(19) United States
(12) Patent Application Publication
(10) Pub. No.: US 2024/0399968 A1
(43) Pub. Date: Dec. 5, 2024

(54) ROD CONNECTOR AND CAR LUGGAGE RACK INCLUDING THE SAME

(71) Applicant: EVERMORE INTERNATIONAL GROUP CO., LTD., GEORGE HILL (AI)

(72) Inventor: Wade CHI, Taipei City (TW)

(21) Appl. No.: 18/329,410

(22) Filed: Jun. 5, 2023

(51) Int. Cl. B60R 9/058; F16B 7/18

(52) U.S. Cl. CPC B60R 9/058; F16B 7/18

(57) ABSTRACT

A rod connector is provided, including two connecting bodies and an operation member. The two connecting bodies are arranged in a first direction and each include an insertion portion and at least one engaging portion which includes an extension section and a protrusion. A side of the extension section is perpendicular to the first direction and connected to the insertion portion, and the protrusion protruding in the first direction from the extension section. The operation member is screwed to the insertion portion of one of the two connecting bodies and movable in the first direction to abut against the insertion portion of the other of the two connecting bodies. Rotation of the operation member drives the two connecting bodies to move in the first direction between a first position and a second position.

### BACKGROUND OF THE INVENTION

### Field of the Invention

The present invention relates to a rod connector and a car luggage rack including the same.

### Description of the Prior Art

Generally, it is common to connect two rods by screwing them together, in which one of the two rods is threaded on its outer surface and the other of the two rods is formed with a threaded hole. As such, the two rods can be screwed to each other or unscrewed from each other. Or, two rods can be inserted into each other first, and at least one bolt or screw is then used to secure the two rods.

However, connection of two rods by screwing them together is not suitable for larger or longer rods because it is hard to drive them to rotate relative to each other. Inserting connection of two rods with securing by at least one bolt or screw requires the two rods have different diametric dimensions which can be cooperative to each other, which results in the complexity of processing and production processes, and which results in failure in connecting the two rods once the insertion end of any of the two rods is damaged or broken.

The present invention is, therefore, arisen to obviate or at least mitigate the above-mentioned disadvantages.

### SUMMARY OF THE INVENTION

The main object of the present invention is to provide a rod connector and a car luggage rack including the same, which is smooth in movement, is good in integrity, has good structural strength, provides good protection, and improves the overall quality.

To achieve the above and other objects, a rod connector is provided, including: two connecting bodies arranged in a first direction, each of the two connecting bodies including an insertion portion and at least one engaging portion, the at least one engaging portion including an extension section and a protrusion, a side of the extension section being perpendicular to the first direction and connected to the insertion portion, the protrusion protruding in the first direction from the extension section; and an operation member screwed to the insertion portion of one of the two connecting bodies and being movable in the first direction to abut against the insertion portion of the other of the two connecting bodies, rotation of the operation member driving the two connecting bodies to move in the first direction between a first position and a second position; wherein when rotation of the operation member drives the two connecting bodies to approach to each other to be located in the first position, the insertion portions of the two connecting bodies are configured to be inserted in a first rod, and the engaging portions of the two connecting bodies are configured to be inserted in an insertion hole of a second rod; when rotation of the operation member drives the two connecting bodies away from each other to be located in the second position, the insertion portions of the two connecting bodies move away from each other to abut against an inner wall of the first rod, and in the first direction a distance between the protrusions of the engaging portions of the two connecting bodies is larger than a diametric dimension of the insertion hole.

To achieve the above and other objects, a car luggage rack is provided, including: a supporting frame extending horizontally, including a plurality of first rods, a plurality of second rods and a plurality of said rod connectors, the plurality of first rods being connected to the plurality of second rods by the plurality of said rod connectors, respectively; and an outer frame disposed around and connected to the supporting frame.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a partial breakdown drawing of FIG. 1;

FIG. 3 is a drawing showing two connecting bodies approaching according to an exemplary embodiment of the present invention;

FIG. 4 is a stereogram of a rod connector of an exemplary embodiment of the present invention;

FIG. 5 is another stereogram of the rod connector of an exemplary embodiment of the present invention;

FIG. 6 is a partial enlarged cross-sectional view showing the two connecting bodies located in a first position according to an exemplary embodiment of the present invention; and

FIG. 7 is a partial enlarged cross-sectional view showing the two connecting bodies located in a second position according to an exemplary embodiment of the present invention.

### DETAILED DESCRIPTION OF THE PREFERRED EMBODIMENTS

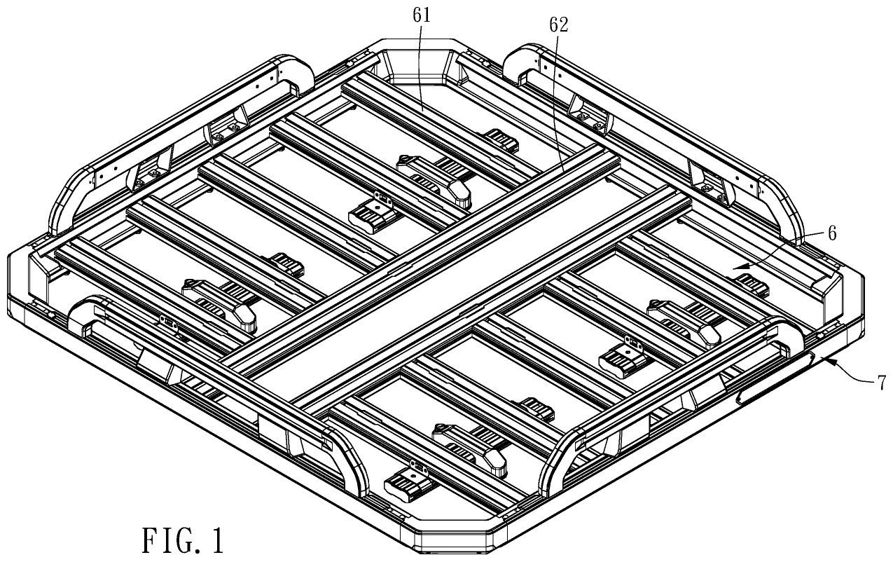

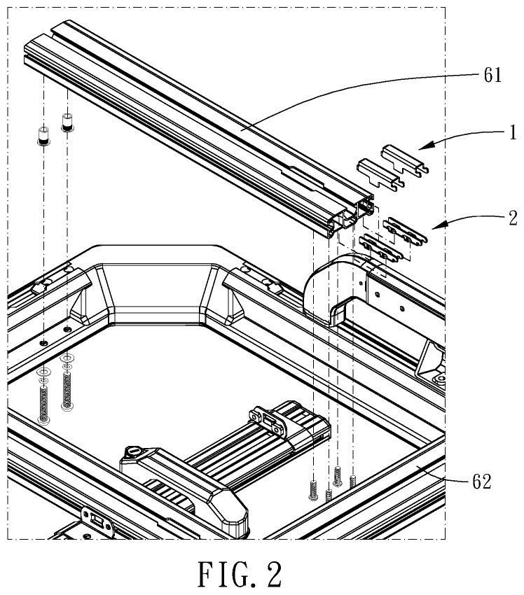

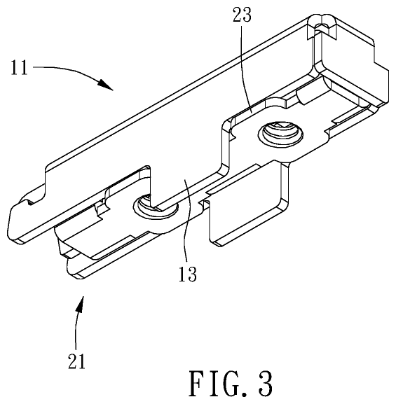

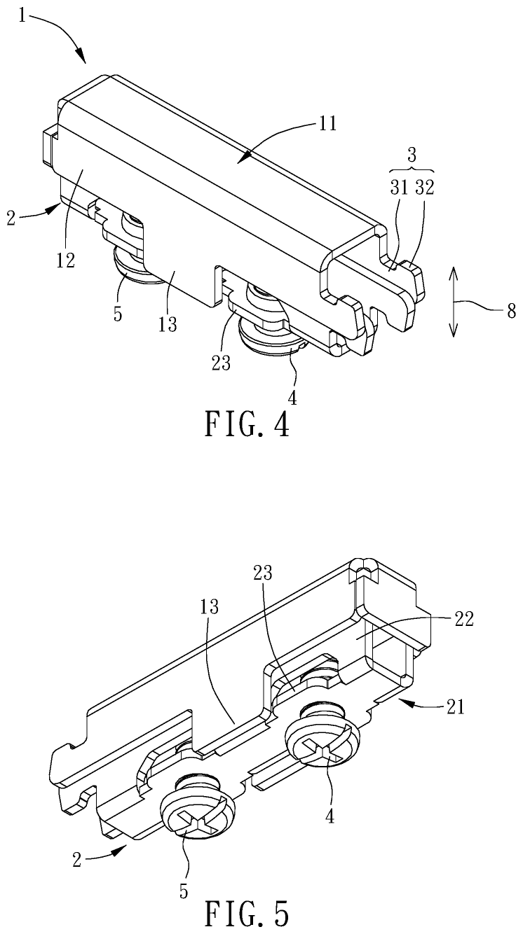

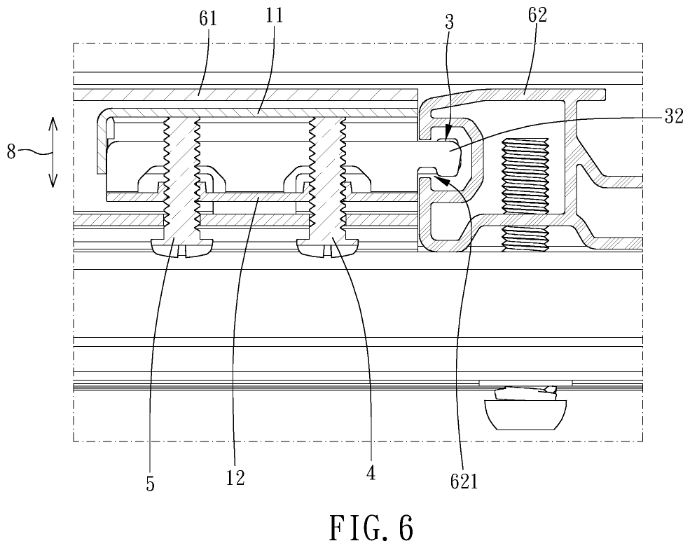

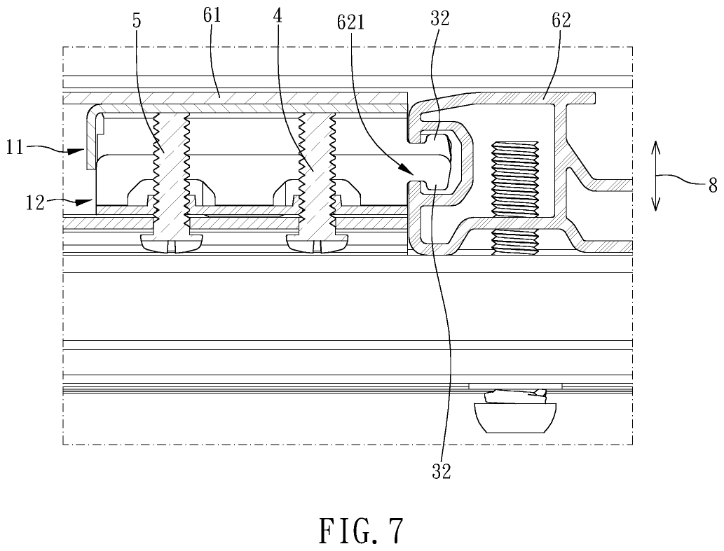

Please refer to FIGS. 1 to 7 for an exemplary embodiment of the present invention. A rod connector of the present invention includes two connecting bodies and an operation member 4.

The two connecting bodies are arranged in a first direction 8, and each of the two connecting bodies includes an insertion portion and at least one engaging portion 3. In this embodiment, the at least one engaging portion includes two engaging portions 3, and the two engaging portions 3 are symmetrically disposed on an end of the insertion portion, which increases engaging area. Specifically, each of the two engaging portions 3 includes an extension section 31 and a protrusion 32, a side of the extension section 31 is perpendicular to the first direction 8 and connected to the insertion portion, and in a direction perpendicular to the first direction 8, the engaging portion 3 has a length smaller than a length of the insertion portion. The protrusion 32 protrudes in the first direction 8 from the extension section 31, and in the first direction 8, the protrusion 32 has a length smaller than a length of the insertion portion.

Specifically, the operation member 4 is screwed to the insertion portion of one of the two connecting bodies and is movable in the first direction 8 to abut against the insertion portion of the other of the two connecting bodies. Rotation of the operation member 4 drives the two connecting bodies to move in the first direction 8 between a first position and a second position. When rotation of the operation member 4 drives the two connecting bodies to approach to each other to be located in the first position, the insertion portions of the two connecting bodies are configured to be inserted in a first rod 61, and the engaging portions 3 of the two connecting bodies are configured to be inserted in an insertion hole 621 of a second rod 62. When rotation of the operation member 4 drives the two connecting bodies away from each other to be located in the second position, the insertion portions of the two connecting bodies move away from each other to abut against an inner wall of the first rod 61, and in the first direction 8 a distance between the protrusions of the engaging portions 3 of the two connecting bodies is larger than a diametric dimension of the insertion hole 621. As such, the engaging portions 3 are blocked by a hole wall defining the insertion hole 621 in a direction perpendicular to the first direction 8 so that the first rod 61 and the second rod 62 are connected to each other.

Since the rod connector is inserted inside the first rod 61 and inside the second rod 62, the rod connector is not exposed to outside and reinforces the combination of the first rod 61 and the second rod 62, and it provides a smooth outer profile of the configuration formed by the first rod 61 and the second rod 62 connected. The first rod 61 and the second rod 62 can be locked or unlocked at the same time by the operation member 4, thus reducing steps of assembling and elements.

Preferably, each of the two connecting bodies is integrally formed of one piece, which provides a strong structure. In this embodiment, each of the two connecting bodies are made from a metal plate by bending, which is easy and quick to manufacture.

Preferably, the rod connector further includes at least one supporting member 5, the at least one supporting member 5 is parallel to the operation member 4 and screwed to the insertion portion of one of the two connecting bodies and is movable in the first direction 8 to abut against the insertion portion of the other of the two connecting bodies. The at least one supporting member 5 is used to share the force of the operation member 4, and the at least one supporting member 5 and the operation member 4 provide stable and good support to the two connecting bodies. In this embodiment, the operation member 4 and the at least one supporting member 5 are screws so that it is easy and quick to operate.

Specifically, the two connecting bodies include a first connecting body 1 and a second connecting body 2, and the first connecting body 1 and the second connecting body 2 are sleeved with each other and relatively movable in the first direction 8. The insertion portion of the first connecting body 1 includes a first member 11 and at least one projection 13, and the at least one projection 13 extends on an end face of at least one first side wall 12 of the first member 11 in the first direction 8. The insertion portion of the second connecting body 2 includes a second member 21 and at least one blocking portion 23, the at least one blocking portion 23 projects form at least one second side wall 22 of the second member 21 in a direction perpendicular to the first direction 8, and the at least one blocking portion 23 and the at least one projection 13 do not overlap in the first direction 8.

Specifically, a cross-section of the first member 11 is U-shaped, and a cross-section of the second member 21 is U-shaped. When the first connecting body 1 and the second connecting body 2 approach, the second member 21 is received inside the first member 11, the end face of the at least one first side wall 12 of the first member 11 abuts the at least one blocking portion 23, and the at least one projection 13 is protrusive beyond the at least one blocking portion 23. When the first connecting body 1 and the second connecting body 2 are urged, the at least one blocking portion 23 can prevent the second member 21 from entirely sinking into the first member 11, and the at least one projection 13 that is protrusive is good for gripping. For example, when the thumb presses the second member 21 in the first direction 8, the thumb can lean against the at least one projection 13 laterally.

Through the operation member 4, the distance between the first connecting body 1 and the second connecting body 2 in the first direction 8 can be controlled and adjusted so that the rod connector can be applied for rods of various sizes. If the rod connector is damaged, it needs only to replace the rod connector with a new one, without replacing the first rod 61 and the second rod 62, which is cost-saving and quick to repair. Moreover, the connection of the first rod 61 and the second rod 62 requires only that the rod diameter of the first rod 61 and the hole diameter of the insertion hole 621 cooperate with each other, and it is relatively simple and easy to process the hole of the insertion hole 621, so that it is convenient for manufacturing and has high assembly precision and processing quality, and so that the diameter of the second rod 62 is not limited.

The present invention further provides a car luggage rack. The car luggage rack includes a supporting frame 6 and an outer frame 7. The supporting frame 6 extends horizontally, and the supporting frame 6 includes a plurality of first rods 61, a plurality of second rods 62 and a plurality of rod connector. The plurality of first rods 61 are connected to the plurality of second rods 62 by the plurality of plurality of rod connectors, respectively. The outer frame 7 is disposed around and connected to the supporting frame 6, for protecting the supporting frame 6.

Preferably, the insertion hole 621 of each of the plurality of second rods 62 is an elongated hole within which the engaging portion 3 of each of the two connecting bodies is slidable, which is adjustable according to various requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rod connector, including:
two connecting bodies arranged in a first direction, each of the two connecting bodies including an insertion portion and at least one engaging portion, the at least one engaging portion including an extension section and a protrusion, a side o protruding in the first direction from f the extension section being perpendicular to the first direction and connected to the insertion portion, the protrusion the extension section; and
an operation member screwed to the insertion portion of one of the two connecting bodies and being movable in the first direction to abut against the insertion portion of the other of the two connecting bodies, rotation of the operation member driving the two connecting bodies to move in the first direction between a first position and a second position;
wherein when rotation of the operation member drives the two connecting bodies to approach to each other to be located in the first position, the insertion portions of the two connecting bodies are configured to be inserted in a first rod, and the engaging portions of the two connecting bodies are configured to be inserted in an insertion hole of a second rod; when rotation of the operation member drives the two connecting bodies away from each other to be located in the second position, the insertion portions of the two connecting bodies move away from each other to abut against an inner wall of the first rod, and in the first direction a distance between the protrusions of the engaging portions of the two connecting bodies is larger than a diametric dimension of the insertion hole.

2. The rod connector of claim 1, wherein in the first direction, the protrusion has a length smaller than a length of the insertion portion.

3. The rod connector of claim 1, wherein the at least one engaging portion includes two engaging portions, and the two engaging portions are symmetrically disposed on an end of the insertion portion.

4. The rod connector of claim 1, wherein each of the two connecting bodies is integrally formed of one piece.

5. The rod connector of claim 1, further including at least one supporting member, wherein the at least one supporting member is parallel to the operation member and screwed to the insertion portion of one of the two connecting bodies and is movable in the first direction to abut against the insertion portion of the other of the two connecting bodies.

6. The rod connector of claim 1, wherein the two connecting bodies include a first connecting body and a second connecting body, and the first connecting body and the second connecting body are sleeved with each other and relatively movable in the first direction.

7. The rod connector of claim 6, wherein the insertion portion of the first connecting body includes a first member and at least one projection, the at least one projection extends on an end face of at least one first side wall of the first member in the first direction, the insertion portion of the second connecting body includes a second member and at least one blocking portion, the at least one blocking portion projects form at least one second side wall of the second member in a direction perpendicular to the first direction, the at least one blocking portion and the at least one projection do not overlap in the first direction, when the first connecting body and the second connecting body approach, the second member is received inside the first member, the end face of the at least one first side wall of the first member abuts the at least one blocking portion, and the at least one projection is protrusive beyond the at least one blocking portion.

8. The rod connector of claim 7, wherein in the first direction, the protrusion has a length smaller than a length of the insertion portion; the at least one engaging portion includes two engaging portions, and the two engaging portions are symmetrically disposed on an end of the insertion portion; each of the two connecting bodies is integrally formed of one piece; the rod connector further includes at least one supporting member, the at least one supporting member is parallel to the operation member and screwed to the insertion portion of one of the two connecting bodies and is movable in the first direction to abut against the insertion portion of the other of the two connecting bodies; in a direction perpendicular to the first direction, the engaging portion has a length smaller than a length of the insertion portion; the two connecting bodies are made from a metal plate; the operation member and at least one supporting member are screws; a cross-section of the first member is U-shaped, and a cross-section of the second member is U-shaped.

9. A car luggage rack, including:
a supporting frame extending horizontally, including a plurality of first rods, a plurality of second rods and a plurality of said rod connectors of claim 1, the plurality of first rods being connected to the plurality of second rods by the plurality of said rod connectors, respectively; and
an outer frame disposed around and connected to the supporting frame.

10. The car luggage rack of claim 9, wherein the insertion hole of each of the plurality of second rods is an elongated hole within which the engaging portion of each of the two connecting bodies is slidable.
